(19) United States
(12) Patent Application Publication
(10) Pub. No.: US 2023/0100234 A1
(43) Pub. Date: Mar. 30, 2023

(54) PREPARATION OF PARAMAGNETIC COMPOUNDS

(71) Applicant: President and Fellows of Harvard College, Cambridge, MD (US)

(72) Inventors: Michael J. Fink, Cambridge, MA (US); Christoffer Karl Abrahamsson, Cambridge, MA (US); George M. Whitesides, Newton, MA (US)

(21) Appl. No.: 17/903,349

(22) Filed: Sep. 6, 2022

Related U.S. Application Data
(60) Provisional application No. 63/241,399, filed on Sep. 7, 2021.

(51) Int. Cl. C07F 5/00; G01N 15/06

(52) U.S. Cl. CPC C07F 5/003; G01N 15/0656; G01N 2015/0687

(57) ABSTRACT

A process for preparing paramagnetic compounds is described. A paramagnetic compound made by the process is described, including its use in density-based analysis by MagLev.

### CROSS-REFERENCE TO RELATED APPLICATIONS

This application claims priority to U.S. Provisional Patent Application No. 63/241,399, filed on Sep. 7, 2021, the contents of which is hereby incorporated by reference in its entirety.

### STATEMENT REGARDING FEDERALLY SPONSORED RESEARCH OR DEVELOPMENT

This invention was made with government support under DE-FG02-00ER45852 awarded by the U.S. Department of Energy. The government has certain rights in the invention.

### INCORPORATION BY REFERENCE

Any patent, patent publication, journal publication, or other document cited herein is expressly incorporated herein by reference in its entirety.

### FIELD OF THE INVENTION

This invention is generally related to paramagnetic compounds soluble in non-aqueous solvents. This invention includes processes for the preparation and use of said paramagnetic compounds, including gadolinium-based paramagnetic compounds.

### BACKGROUND OF THE INVENTION

Non-aqueous liquids comprising paramagnetic compounds, or hydrophobic paramagnetic liquids, are useful for a variety of applications, such as analysis of hydrophobic substances. For example, hydrophobic paramagnetic liquids are useful for density-based separations of mixtures comprising hydrophobic substances, such as separations of mixtures of illicit drugs by magneto-Archimedes levitation (“MagLev”). See, e.g., WO 2020/190845 A1; Angew. Chem. Int. Ed. 2020, 59:874-81; Angew. Chem. Int. Ed. 2020, 59:17810-55. Some applications require large volumes or concentrations of the hydrophobic paramagnetic liquid relative to the analyte. Certain applications, like forensic analyses and other field testing, require that the hydrophobic paramagnetic liquid be used only once and have high purity and reproducibility. As MagLev often involves optical detection, clarity of the hydrophobic paramagnetic liquid is also important.

Some paramagnetic compounds compatible with non-aqueous solvents, such as, but not limited to, gadolinium tris(dipivaloylmethanato) gadolinium trioctylphosphine (“Gd(DPM)₃TOPO”) and gadolinium tris(acetylacetonate) gadolinium trioctylphosphine (“Gd(acac)₃TOPO”), are not commercially available and must be synthesized “in-house.” Considerable variability in the quality (e.g., purity and clarity) of both synthetic and commercial starting materials and final products, poor yields and scalability of existing synthetic procedures, and the need for sophisticated synthetic expertise and equipment can contribute significant cost. This coupled with the requirements for field testing applications discussed above may even hinder the use of hydrophobic paramagnetic liquid-based analysis techniques for such applications.

Another challenge to preparation of paramagnetic compounds is that standard characterization techniques, like nuclear magnetic resonance, are ineffective because of the paramagneticity.

Accordingly, new processes for the preparation of paramagnetic compounds compatible with non-aqueous solvents remains an unmet need for realizing full applicability of hydrophobic paramagnetic liquids.

### SUMMARY OF THE INVENTION

The present application meets the unmet need discussed above in disclosing new processes for the preparation of paramagnetic compounds compatible with non-aqueous solvents, that reproducibly generate pure, clarified products in high (even quantitative) yield and on scale, without the need for complex synthetic transformations, purification steps, and equipment. This resulted in about a 30-fold reduction in the materials costs for MagLev analysis. The inventors surprisingly discovered that the following enabled this innovation: (i) maintaining all reagents in about stoichiometric equivalence across all steps; (ii) removal of byproducts and unreacted reagents by liquid-liquid extraction; (iii) a telescoped procedure where the intermediate product is not purified; (iv) mild, atmospheric conditions using non-hazardous solvents and standard laboratory equipment; (v) near quantitative yield for all steps; (vi) linear scalability; and/or (vii) inexpensive source of gadolinium.

In one aspect, a process for synthesizing a paramagnetic compound comprises the steps of:
combining a first ligand precursor and a base in a first solvent to form a mixture;
allowing time for the first ligand precursor and the base to react to form a first ligand;
adding a metal compound to the mixture;
allowing time for the metal compound, the first ligand, and the base to react to form a ligand-metal intermediate;
isolating the ligand-metal intermediate from the mixture, subjecting it to liquid-liquid extraction, and concentrating it;
dissolving the ligand-metal intermediate in a second solvent to form a solution;
adding a second ligand to the solution;
allowing time for the second ligand and the ligand-metal intermediate to react to form the paramagnetic compound; and
isolating, and optionally purifying, the paramagnetic compound;
wherein:
the paramagnetic compound comprises a paramagnetic metal and at least one ligand that coordinates to the paramagnetic metal via electron donation; and
the paramagnetic compound is soluble in a non-aqueous solvent.

In another aspect, a paramagnetic compound is one made by the process according to any one of the embodiments described herein.

In yet another aspect, a magnetic levitation system comprises:
a first and second magnets having surfaces of their like-poles facing each other; and
a container disposed between the first and second magnets' like poles and containing a solution comprising a paramagnetic compound made by the process according to any one of the embodiments described herein in a non-aqueous solvent.

In a further aspect, a method of analyzing a sample comprising one or more solid compounds, comprises:
(a) providing the magnetic levitation system of any one of the embodiments described herein;
(b) depositing the sample in the solution;
(c) allowing each of the solid compounds in the sample to migrate to a position in the container indicative of its density;
(d) analyzing one or more of the solid compounds to determine or confirm its identity;
(e) generating a profile of the position of the one or more compounds relative to the container;
(f) generating a database comprising a plurality of profiles, each of which corresponds to a known solid compound or a known mixture of solid compounds; and
(g) comparing the profile of the sample to the profiles in the database to determine its identity.

Any one of the embodiments disclosed herein may be properly combined with any other embodiment disclosed herein. The combination of any one of the embodiments disclosed herein with any other embodiments disclosed herein is expressly contemplated. Specifically, the selection of one or more embodiments for one substituent group can be properly combined with the selection of one or more particular embodiments for any other substituent group. Such combination can be made in any one or more embodiments of the application described herein or any formula described herein.

### DESCRIPTION OF THE DRAWINGS

The application is described with reference to the following figures, which are presented for the purpose of illustration only and are not intended to be limiting. In the Drawings:

FIG. 1A shows an apparatus for MagLev separation of mixtures of illicit drugs using Gd(DPM)₃TOPO, according to one or more embodiments.

FIG. 1B shows an apparatus for MagLev separation of mixtures of illicit drugs using a solution of Gd(DPM)₃TOPO, according to one or more embodiments.

FIG. 2 shows a comparison of the FT-IR spectrum of a sample of Gd(DPM)₃TOPO prepared according to one or more embodiments described herein, with a sample of Gd(DPM)₃TOPO synthesized using an existing procedure.

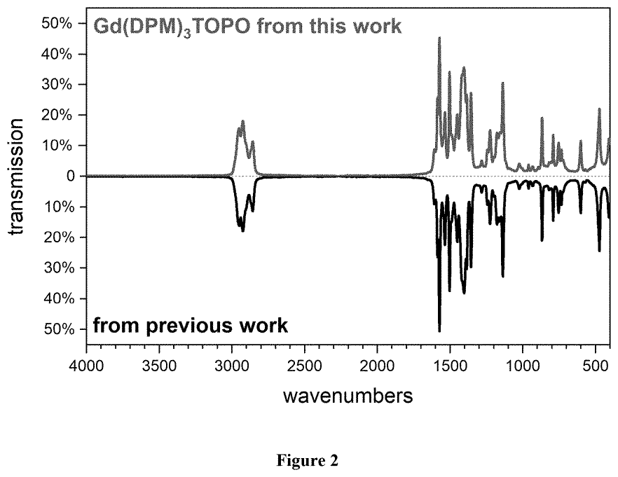

FIG. 3 shows levitation of glass beads in a MagLev device using a solution of Gd(DPM)₃TOPO, according to one or more embodiments.

### DETAILED DESCRIPTION OF THE INVENTION

In one aspect, a process for synthesizing a paramagnetic compound comprises the steps of:
combining a first ligand precursor and a base in a first solvent to form a mixture;
allowing time for the first ligand precursor and the base to react to form a first ligand;
adding a metal compound to the mixture;
allowing time for the metal compound, the first ligand, and the base to react to form a ligand-metal intermediate;
isolating the ligand-metal intermediate from the mixture, subjecting it to liquid-liquid extraction, and concentrating it;
dissolving the ligand-metal intermediate in a second solvent to form a solution;
adding a second ligand to the solution;
allowing time for the second ligand and the ligand-metal intermediate to react to form the paramagnetic compound; and
isolating, and optionally purifying, the paramagnetic compound;
wherein:
the paramagnetic compound comprises a paramagnetic metal and at least one ligand that coordinates to the paramagnetic metal via electron donation; and
the paramagnetic compound is soluble in a non-aqueous solvent.

In some embodiments, the first ligand precursor, base, and/or metal compound are in about stoichiometric equivalence. In some embodiments, the ligand-metal intermediate and second ligand are in about stoichiometric equivalence.

In some embodiments, the first solvent is water, a C₁-C₄ alcohol, or a mixture thereof. In some embodiments, the first solvent is water, methanol, ethanol, propanol, isopropanol, butanol, isobutanol, tert-butanol, or mixtures thereof. In some embodiments, the first solvent is water, ethanol, or a mixture thereof.

In some embodiments, the second solvent is a hydrocarbon solvent. In some embodiments, the second solvent is hexane or isomers thereof, heptane or isomers thereof, or mixtures thereof. In some embodiments, the second solvent is hexanes.

In some embodiments, the first ligand precursor comprises a dialdehyde, a ketoaldehyde, diketone, a bipyridine, a phenanthroline, a diamine, a malonamide, a β-ketoester, or a β-ketoamide. In some embodiments, the first ligand precursor is a compound with the general structure of

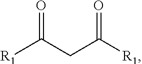

wherein each occurrence of R₁ is independently H, (C₁-C₂₀)alkyl, (C₂-C₂₀)alkenyl, (C₂-C₂₀)alkynyl, (C₃-C₁₀)cycloalkyl, (C₆-C₁₀)aryl, or (C₆-C₁₀)heteroaryl, each of which is optionally substituted with one or more substituents selected from the group consisting of halogen, R^{a}, OR^{a}, NR^{a}R^{b}, COR^{a}, CO₂R^{a}, or CONR^{a}R^{b}; and where R^{a} and R^{b} are independently selected from the group consisting of hydrogen and (C₁-C₆)alkyl.

In some embodiments, each occurrence of R₁ is independently (C₁-C₁₀)alkyl or (C₆-C₁₀)aryl. In some embodiments, each occurrence of R₁ is (C₁-C₆)alkyl. In some embodiments, each occurrence of R₁ is methyl, ethyl, propyl, butyl, pentyl, hexyl, heptyl, octyl, nonyl, decyl, phenyl, or isomers thereof.

In some embodiments, the metal compound is a scandium, titanium, vanadium, chromium, manganese, iron, cobalt, nickel, cerium, praseodymium, neodymium, europium, gadolinium, terbium, dysprosium, copper, holmium, erbium, thulium, or lanthanum salt, hydrate, or oxide. In some embodiments, the metal compound is a gadolinium salt, hydrate, or oxide. In some embodiments, the metal compound is a gadolinium nitrate hydrate, a gadolinium oxide, or a gadolinium halide. In some embodiments, the metal compound is Gd(NO₃)₃.6H₂O, Gd₂O₃, or GdCl₃.

In some embodiments, the base is a hydroxide base. In some embodiments, the base is an alkali or alkaline metal hydroxide. In some embodiments, the base is NaOH or KOH.

In some embodiments, the second ligand is a compound with the general structure of

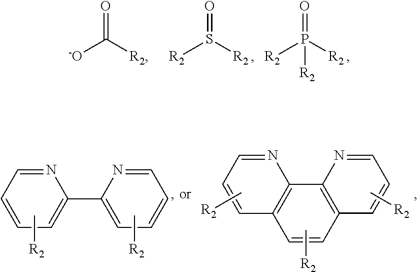

wherein each occurrence of R₂ is independently H, (C₁-C₂₀)alkyl, (C₂-C₂₀)alkenyl, (C₂-C₂₀)alkynyl, (C₃-C₁₀)cycloalkyl, (C₆-C₁₀)aryl, or (C₆-C₁₀)heteroaryl, each of which is optionally substituted with one or more substituents selected from the group consisting of halogen, R^{a}, OR^{a}, NR^{a}R^{b}, COR^{a}, CO₂R^{a}, or CONR^{a}R^{b}; and where R^{a} and R^{b} are independently selected from the group consisting of hydrogen and (C₁-C₆)alkyl. In some embodiments, the second ligand is a compound with the general structure of

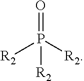

In some embodiments, each occurrence of R₂ is independently (C₁-C₁₀)alkyl or (C₆-C₁₀)aryl. In some embodiments, each occurrence of R₂ is (C₁-C₁₀)alkyl. In some embodiments, each occurrence of R₂ is independently methyl, ethyl, propyl, butyl, pentyl, hexyl, heptyl, octyl, nonyl, decyl, phenyl, or isomers thereof. In some embodiments, each occurrence of R₂ is octyl.

In some embodiments, the paramagnetic compound is

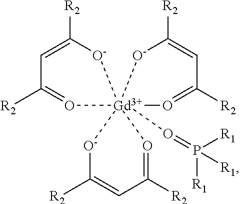

wherein each occurrence of R₁ and R₂ is independently (C₁-C₁₀)alkyl or (C₆-C₁₀)aryl. In some embodiments, the paramagnetic compound is

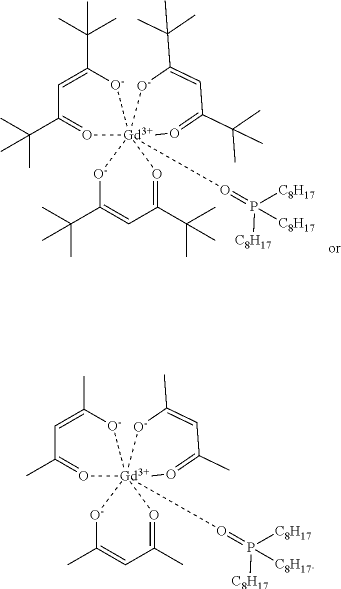

Additional examples of paramagnetic compounds are disclosed in WO 2020/190845 A1.

In some embodiments, the liquid-liquid extraction comprises an aqueous phase and an organic phase. In some embodiments, the organic phase comprises a hydrocarbon solvent. In some embodiments, the organic phase comprises hexane or isomers thereof, heptane or isomers thereof, or mixtures thereof. In some embodiments, the organic phase comprises hexanes.

In some embodiments, the overall yield of the paramagnetic compound is between about 95 and 100%, inclusive. In some embodiments, the overall yield of the paramagnetic compound is between about 98 and 100%, inclusive.

In some embodiments, each step is performed under atmospheric conditions.

In some embodiments, each time is between about 0.5 minutes and 2 days, inclusive.

In some embodiments, the scale of the process is between about 1 mg to about 1 kg, inclusive. In some embodiments, the scale of the process is between about 1 mg to about 200 mg, inclusive.

In some embodiments, the non-aqueous solvent is selected from the group consisting of acyclic and cyclic hydrocarbons, acyclic and cyclic halo- or per-halo hydrocarbons, aromatic hydrocarbons, acyclic and cyclic ethers, and acyclic and cyclic aldehydes, ketones, esters, amides, sulfides, sulfoxides, and sulfones, and a combination thereof. In some embodiments, the non-aqueous solvent is a hydrocarbon, per-halo hydrocarbon, or combination thereof. In some embodiments, the non-aqueous solvent is hexanes, tetrachloroethylene, or a combination thereof.

In certain embodiments,
the first ligand precursor is dipivaloylmethane;
the base is sodium hydroxide;
the metal compound is Gd(NO₃)₃.6H₂O;
the first solvent is a mixture of ethanol and water;
the ligand-metal intermediate is

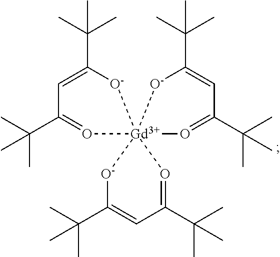

the second solvent is hexanes;
the second ligand is trioctylphosphine oxide;
and the paramagnetic compound is

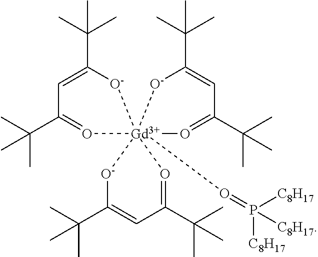

In certain embodiments,
the liquid-liquid extraction comprises an aqueous phase and an organic phase comprising hexanes;
the overall yield of the paramagnetic compound is between about 98 and 100%, inclusive;
each step is performed under atmospheric conditions;
each time is between about 0.5 minutes and 2 days, inclusive; and
the scale of the process is between about 1 mg to about 1 kg, inclusive.

In another aspect, a paramagnetic compound is one made by the process according to any one of the embodiments described herein. In some embodiments, the paramagnetic compound is

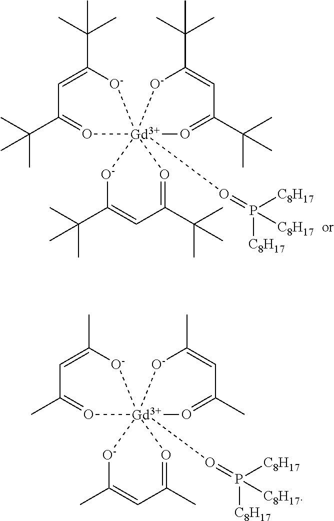

In yet another aspect, a magnetic levitation system comprises:
a first and second magnets having surfaces of their like-poles facing each other; and
a container disposed between the first and second magnets' like poles and containing a solution comprising a paramagnetic compound made by the process according to any one of the embodiments described herein in a non-aqueous solvent.

In a further aspect, a method of analyzing a sample comprising one or more solid compounds, comprises:
(a) providing the magnetic levitation system of any one of the embodiments described herein;
(b) depositing the sample in the solution;
(c) allowing each of the solid compounds in the sample to migrate to a position in the container indicative of its density;
(d) analyzing one or more of the solid compounds to determine or confirm its identity;
(e) generating a profile of the position of the one or more compounds relative to the container;
(f) generating a database comprising a plurality of profiles, each of which corresponds to a known solid compound or a known mixture of solid compounds; and
(g) comparing the profile of the sample to the profiles in the database to determine its identity.

In some embodiments, the sample comprises one or more controlled substances, adulterants, diluents, or a combination thereof.

The representative examples which follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that the contents of those cited references are incorporated herein by reference to help illustrate the state of the art. The following examples contain important additional information, exemplification, and guidance which can be adapted to the practice of this invention in its various embodiments and equivalents thereof.

### EXAMPLES

### Example 1: Scalable Synthesis of a Gadolinium-Based Hydrophobic Paramagnetic Liquid

### Summary

Problem: How do you synthesize a paramagnetic hydrophobic liquid, used for, e.g., analyses of powdered illicit drugs, without sophisticated procedures on large scale with high yield to reduce the material cost of, e.g., hydrophobic MagLev separations?

Solution: Use simple techniques (e.g., filtration and liquid-liquid extraction), equimolar stoichiometry in all reaction steps, and non-hazardous solvents to synthesize the hydrophobic paramagnetic liquid with high efficiency.

Surprise: The protocol is readily scalable from about 5 g scale to about 150 g scale using standard lab equipment (e.g., flasks up to 2 L volume), and highly reproducible.

Benefits: The protocol described in this Example reduced the material cost of hydrophobic MagLev analyses from about 30 USD to about 1 USD per test and is likely amenable to further up-scaling to further reduce labor cost. Since the paramagnetic fluid contributes most to the (material) bill of performing certain MagLev analyses, this work may accelerate the use and development of hydrophobic MagLev, including in the analysis of samples of illicit drugs.

### Background

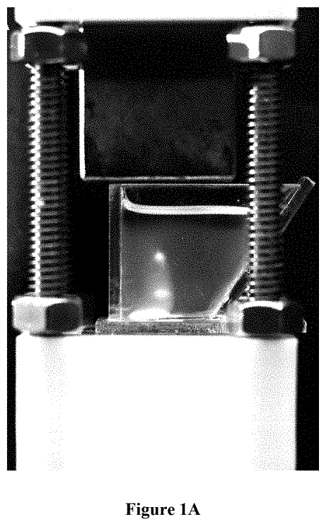

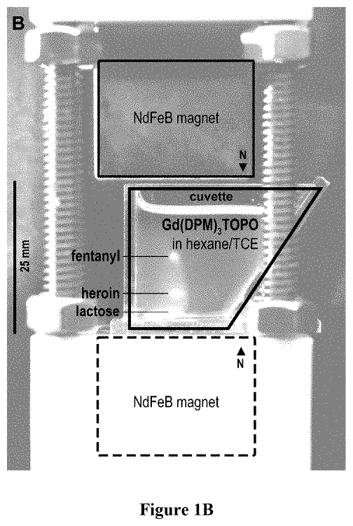

Methods to separate powdered samples of illicit drugs (e.g., fentanyl, heroin, cocaine, and methamphetamine) can be based on differences in density using MagLev in paramagnetic hydrophobic liquids. See, e.g., WO 2020/190845 A1; Angew. Chem. Int. Ed. 2020, 59:874-81. For example, FIGS. 1A-B show separation of a mixture of fentanyl, heroin, and lactose using a MagLev apparatus comprising NdFeB magnets, a cuvette, and a solution of Gd(DPM)₃TOPO in hexane and trichloroethylene. The image was taken after 30 minutes. This method can be used in collaboration with law enforcement, e.g., the U.S. Drug Enforcement Agency, to isolate active drug components from complex matrices of adulterants and diluents, and further allows the presumptive identification of scheduled substances. See id.

Analyses of small samples of solids (e.g., about 50 mg) using MagLev requires about, e.g., 3 mL of a paramagnetic liquid for each analysis. The paramagnetic compound component is typically required at high concentration (e.g., 0.4-1.1 M). With hydrophobic paramagnetic compounds (e.g., complexes of gadolinium with large organic ligands), the high molar concentration also corresponds to a high mass fraction (e.g., about 50% w/w of the paramagnetic liquid) because of their relatively high molecular weight (e.g., 1.094 g/mol for Gd(DPM)₃TOPO) in comparison to the paramagnetic salts often employed in aqueous MagLev (see Angew. Chem. Int. Ed. 2020, 59:17810-55), therefore contributing substantially to the material cost of performing an analysis (e.g., about 30 USD per test using Gd(DPM)₃TOPO). Although the liquid can, in principle, be recycled after the analysis because the analytes are insoluble, potential contamination with illicit substances or other legal constraints regarding the use of this technology in forensics may prevent their use after recovery.

The paramagnetic complexes Gd(DPM)₃TOPO and Gd(acac)₃TOPO are not commercially available and thus must be synthesized “in-house” or by custom manufacturing. Users of MagLev may not have access to sophisticated synthetic equipment and/or the requisite expertise to perform complex synthetic procedures and purifications. This, in addition to the material costs discussed above, can present a barrier to field application of MagLev.

The immediate precursor to the paramagnetic hydrophobic liquid Gd(DPM)₃TOPO, tris(dipivaloylmethanato) gadolinium (Gd(DPM)₃), is commercially available at a price of 11-40 USD per gram. Vendors on the low end of that range may synthesize on demand, resulting in long lead times. Variations in purity between different sources can occur, which can result in hazy and yellowish final products; both can be detrimental to the quality of the analysis using MagLev, which can depend on visual or camera-assisted measurement.

Gd(DPM)₃ can be sourced commercially as a starting material to synthesize Gd(DPM)₃TOPO. Not accounting for labor and minor cost items, the material cost of preparing Gd(DPM)₃TOPO from the commercially available precursor Gd(DPM)₃ amounted to a cost contribution of about 30 USD per analysis of illicit drugs using MagLev.

Few published studies using Gd(DPM)₃ (or other diketonide lanthanide complexes) included a synthetic procedure. See, e.g., Inorg. Chem. 1963, 2:73-6; J. Am. Chem. Soc. 1965, 87:5254-6; J. Am. Chem. Soc. 1969, 91:3476-81; Thermochim. Acta 1985, 88:407-14; Magn. Reson. Imaging 1994, 12:299-300; J. Cryst. Growth 2003, 250:423-30; Tetrahedron 2003, 59:10477-83. No published studies explicitly state the obtained yield, but numbers from similar reactions (using other lanthanides or transition metals) in the same papers or indirect quantitative information in the descriptions indicate a range from about 16-92%. All published protocols used gadolinium nitrate, ethanol-water mixtures, and sodium hydroxide to deprotonate the 1,3-diketone. They relied on partial removal of the solvents by distillation, recrystallization, and/or fractional sublimation under reduced pressure to remove the by-product sodium nitrate and purify the desired Gd(DPM)₃ product.

While the hydrophobic properties of Gd(DPM)₃TOPO were previously reported (see, e.g., Magn. Reson. Imaging 1994, 12:299-300), no experimental procedure was given. A synthetic protocol starting from Gd(DPM)₃ was reported in Angew. Chem. Int. Ed. 2020, 59:874-81.

There are certain requirements in purity (regarding gadolinium content and residual solvent) and in quality (color and clarity) of Gd(DPM)₃TOPO for its use in density-based separations of, e.g., illicit drugs.

### Methods

A process for the preparation of Gd(DPM)₃TOPO was developed that requires only filtration and liquid-liquid extraction as purification steps, using standard lab equipment (e.g., flasks and funnels up to 2 L volume, sinter funnels, and magnetic stir plates). The process was tested on a 150 g scale in a single batch, affording Gd(DPM)₃TOPO in 98% yield (enough material for about 100-150 analyses) with the desired characteristics in purity, color, and clarity. The process works under atmospheric lab conditions, using non-hazardous solvents (e.g., water, ethanol, hexanes), and using cheap sources for gadolinium (e.g., gadolinium nitrate hexahydrate).

The synthetic steps for the synthesis of Gd(DPM)₃TOPO from dipivaloylmethane (DPM), gadolinium nitrate hydrate, and trioctylphosphine oxide (TOPO) are depicted below in Scheme 1.

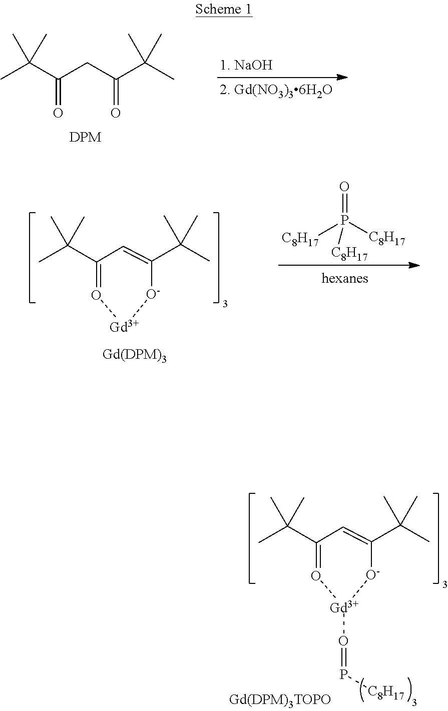

To reduce the experimental complexity of work-up and purification, the synthesis was designed aiming for the minimum amount of undesired products, while still maintaining high (quantitative) yield. The first two reactions (deprotonation of DPM and subsequent formation of Gd(DPM)₃ from the anion of DPM and Gd(NO₃)₃) did not require any of the reagents in excess to achieve quantitative conversion quickly. The by-product of the reaction (sodium nitrate) and any unreacted base were removed by liquid-liquid extraction. The intermediate product, Gd(DPM)₃ was therefore obtained in sufficient purity that its isolation and purification by recrystallization was not required. The intermediate product Gd(DPM)₃ was obtained from liquid-liquid extraction in a solvent that is compatible with the third reaction (formation of Gd(DPM)₃TOPO from the intermediate product and TOPO). The third reaction was performed with equimolar stoichiometry and was still able to achieve quantitative conversion quickly.

Gadolinium nitrate hexahydrate was chosen as the source for the paramagnetic metal due to its second-lowest price per mol gadolinium and its good solubility in water. The cheapest source, gadolinium oxide, is poorly soluble in water. The conversion of the oxide to the nitrate, often done using concentrated nitric acid (see Thermochim. Acta 1985, 88:407-14) and the associated requirements for neutralization of reactant and waste streams and handling of caustic solutions seemed impractical for the goals of this study, although the substantial difference in cost may provide sufficient economic motivation for certain users (see Table 1 below).

TABLE 1
Cost and properties of certain sources of gadolinium.

| | Price^{b} per | Price^{b} per | Solubility |
|---|---|---|---|
| Gd source^{a} | gram (USD) | mol (USD) | in water |
| Chloride hexahydrate | 1.7 | 621 | soluble |
| Nitrate hexahydrate | 1.0 | 456 | highly soluble |
| Oxide | 0.8 | 154 | insoluble |

^{a}Gadolinium with 99.9% purity in trace metal content (lowest available purity).
^{b}Lowest achievable prices for suppliers considered.

### Results

Several experiments on the 10-gram scale were performed to test hypotheses regarding stoichiometry and yield of the first step.

The suspension resulting from mixing a lanthanide chloride and the sodium diketonide in an ethanol-water mixture was concentrated by distillation, and the product was obtained by precipitation with water, filtration, and subsequent vacuum sublimation. The precipitate agglomerated and adhered to glass and metal. This precipitate was not efficiently collectable by filtration or decanting due to substantial loss of material and the time-consuming nature of such a procedure. This outcome did not change when the amount of sodium hydroxide was increased to a 5% molar excess to ensure complete deprotonation of the diketone.

The initially unsuccessful protocol described in the preceding paragraph was further adapted, keeping the same solvent mixture (1:1 ethanol-water) and concentrations (about 1 M solutions of DPM and NaOH, and about 0.67 M solution of gadolinium nitrate) but omitting the removal of solvent by distillation and the precipitation of the product by addition of water. Instead, the viscous, oily crude product was collected by carefully decanting the supernatant and coarse filtration of that solution to maximize yield, and purification by liquid-liquid extraction.

A common, cheap, commercially available mixture of hexane isomers (“hexanes”) was chosen as the solvent for extraction of the aqueous reaction mixture. The intermediate Gd(DPM)₃ complex was sufficiently soluble in pure n-hexane, pure n-heptane, or hexanes.

The biphasic liquid-liquid extraction of the product from the ethanol-water mixture into the hexane layer proceeded with fast phase separation and without any emulsions forming. Gd(DPM)₃ was isolated from a reaction on the 10 g scale in 99% yield as a yellow solid. While pure Gd(DPM)₃ is colorless, no meaningful differences between the material synthesized as described herein and colorless Gd(DPM)₃ from commercial sources was observed.

Various hydrocarbons were tested as solvents for the synthesis of Gd(DPM)₃TOPO from Gd(DPM)₃ (using colorless Gd(DPM)₃ obtained from various commercial suppliers or yellow Gd(DPM)₃ from prior syntheses). All solvents (n-hexane, n-heptane, and hexanes; technical or analytical grade) gave indistinguishable results on various scales (3 g, 13 g, 31 g, and 46 g). Gd(DPM)₃TOPO was obtained in 99-100% yield, with indistinguishable infrared spectra that indicated complete removal of the solvent within detection limits. Heating the bath to 40-60° C. during evaporation of the solvent led to more intense yellow coloration of the product than when keeping the temperature below 40° C., which allowed colorless material to be obtained. With purchased starting material, the color and clarity of Gd(DPM)₃TOPO varied between suppliers and batches of Gd(DPM)₃.

A telescoped synthesis of Gd(DPM)₃TOPO from DPM and gadolinium nitrate was performed without isolation of Gd(DPM)₃, first on the 10 g scale. The reactions yielded Gd(DPM)₃TOPO in 98-100%.

It was investigated whether the loss of material might be due to incomplete conversion in the first step, by performing a reaction using 5% molar excess of the gadolinium salt, which led to difficulties in work-up and the formation of a hazy product. The equimolar ratio was thus maintained for scale-up.

Using linear scaling, the telescoped synthesis of Gd(DPM)₃TOPO was performed on a 156 g scale in 98% yield. No differences to the smaller scale or the individual reactions were observed, except (i) during liquid-liquid extraction, a fine precipitate was observed that would not dissolve in either the organic or aqueous layers, even with repeated washings with both solvents (this material was ultimately combined with the main solution of Gd(DPM)₃); and (ii) in the second step, the solution did not become clear after overnight stirring. Accordingly, the solution was filtered through a fine filter and about 1.8 g of a fine, almost colorless powder was isolated. Analysis by infrared spectroscopy showed that it contained a substantial amount of Gd(DPM)₃ and/or Gd(DPM)₃TOPO, among other, unidentified components.

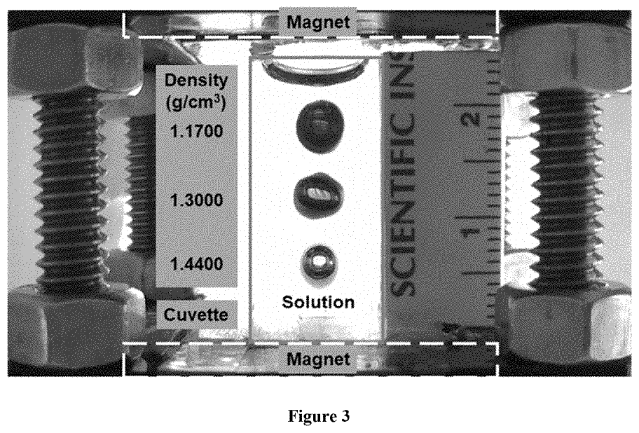

The identity, purity, and functionality of Gd(DPM)₃TOPO obtained using the protocol described herein was assessed using infrared spectroscopy (see FIG. 3; the top and bottom spectra are nearly identical, with cosine similarity of 0.999 and Spearman's rank order correlation of 0.959) and MagLev (see FIG. 4). FIG. 4 shows levitation of glass bead density standards in a methacrylate cuvette filled with a paramagnetic medium consisting of Gd(DPM)₃TOPO dissolved in tetrachloroethylene. The NeFeB magnets (0.5 T), which were arranged with like poles facing to repel each other, were placed in two plastic holders that were held together by threaded rods with hex nuts, forming the MagLev device. See, e.g., Density Determination and Separation via Magnetic Levitation; in Leading Edge Techniques in Forensic Trace Evidence Analysis: More New Trace Analysis Methods; Blackledge, R. D., Ed.; 2021. No significant difference was observed compared to material obtained via existing, more costly, procedures—for separations of illicit drugs using MagLev.

### Additional Experimental Details

### Materials and Suppliers

All reagents and solvents were used as supplied. Reactions were carried out in standard glassware under atmospheric conditions. Note on the use of common disposable cuvettes with apolar solvents: common disposable cuvettes made from polystyrene may dissolve when this type of paramagnetic medium is used. Disposable UV-grade polymethacrylate cuvettes (Sigma Aldrich cat. no. Z188018) were therefore used, that were cut with a band saw to a height of 25 mm (about 2.5 mL capacity) to fit between the faces of the two magnets in the MagLev device.

TABLE 2
Reagents and solvents used.

| | Abbreviation/ | | | | |
|---|---|---|---|---|---|
| Chemical name | Formula | CAS no. | Supplier | Catalog no. | Purity |
| Dipivaloylmethane | DPM | 1118-71-4 | Matrix Scientific/VWR | 003516 | 95% |
| Ethanol | C₂H₅OH or EtOH | 64-17-5 | Koptec/VWR | 71002 | 96% |
| Water | H₂O | | MilliQ fountain | | >99% |
| Gadolinium nitrate | Gd(NO₃)₃•6H₂O | 94219-55-3 | Beantown Chemical | 124970 | 99.9% |
| hexahydrate | | | | | |
| Sodium hydroxide | NaOH | 1310-73-2 | VWR Chemicals BDH | BDH7222 | |
| Hexane, mixture of isomers | | 110-54-3 | VWR Chemicals BDH | BDH1129 | >98.5% |
| Trioctylphosphine oxide | TOPO | 78-50-2 | Sigma-Aldrich | 223301 | 99% |

TABLE 3
Equipment and sizes on two scales.

| | | |
|---|---|---|
| | 10 mmol scale | 141 mmol scale |
| Item | (~11 g product) | (~156 g product) |

| | | | | |
|---|---|---|---|---|
| Erlenmeyer flasks | 100 | mL | 250 | mL |
| | 2 × 250 | mL | 1000 | mL |
| | | | 2000 | mL |

| | | |
|---|---|---|
| Glass rod | 1 | 1 |

| | | | | |
|---|---|---|---|---|
| Suction flask | 250 or 500 | mL | 500 | mL |
| Separation funnel | 500 | mL | 2000 | mL |
| Round-bottom flask | 1000 | mL | 2000 | mL |

### Synthesis of Gd(DPM)₃TOPO on a 150 g Scale.

DPM (78.7 g, 427 mmol, 3 equivalents) was weighed in a beaker (to 0.1 g accuracy) and then transferred to a 2 L Erlenmeyer flask using ethanol and mixed with more ethanol (about 1 mL ethanol per mmol DPM; 430 mL in total) using a crossbar magnetic stirrer. In parallel, gadolinium nitrate hexahydrate (63.68 g, 141 mmol, 1 equivalent) was dissolved in deionized water (280 mL; 2 mL water per mmol gadolinium) in a 1 L Erlenmeyer flask under vigorous stirring to create a homogeneous but hazy solution for addition later.

A 1.0 M aqueous solution of sodium hydroxide (427 mL; volume measured in a graduated 500 mL measuring cylinder; 5 mL graduations) was added to the ethanolic solution of DPM in 5 approximately equal portions over approximately two minutes, causing the temperature of the mixture to rise from 22° C. (room temperature) to 30° C.; the flask was not cooled in any way. Upon every addition of the base, the solution became turbid and then clear again with stirring.

Directly afterwards, the aqueous solution of gadolinium nitrate was added via a funnel in a steady stream over 1-2 minutes; the vessel was rinsed into with a small amount of water, which was also added to the reaction. Immediately upon start of the addition, the intermediate product Gd(DPM)₃ precipitated as small solids, which agglomerated with stirring. The suspension was stirred for 1 hour. After 30-50 minutes, the initially fine and free-flowing solids had agglomerated to an oily, bright yellow mass.

The supernatant was decanted carefully, using a glass rod to keep most of the floating product in the flask and catching the rest on a coarse sinter funnel (150 μm pore size). The product was washed three times with water (3×250 mL) in the Erlenmeyer flask, repeating the careful decanting process and collecting all co-decanted product on the same sinter funnel. The product became more viscous and stickier with every washing step.

The product on the sinter funnel was collected by dissolving it in hexanes (approximately 500 mL) and sucking the solution through the funnel. This solution plus more hexanes (1.3-1.4 L) was added to the gooey residue in the Erlenmeyer flask (total approximately 2.0 L solution) to dissolve all the product. The resulting light-yellow solution was transferred to a separation funnel to remove the aqueous residue, which was re-extracted with hexanes. (A fine colorless powder was found, which had not been observed in experiments on smaller scales using the same protocol. It partitioned between the liquid phases and appeared insoluble in either the aqueous or the hexane phases; it was always combined with the product during the liquid-liquid separation process.)

All vessels were washed thoroughly with hexanes to ensure quantitative transfers of material, resulting in a final volume of approximately 3 L, which was concentrated in stages in a 2 L round-bottom flask on a standard rotary evaporator. The intermediate product Gd(DPM)₃ was obtained as a yellow semi-solid with substantial solvent content (101 g expected, 108 g obtained). Infrared spectroscopy (FTIR-ATR) measurements on the intermediate indicated no residual hexane in the product after rotary evaporation.

The second reaction was performed in the same flask used for concentration. Hexanes (1.0 L) were added, and the was flask swirled by hand until a homogeneous solution had formed. A large stir bar was added, and the flask set on a magnetic stir plate before TOPO (55.04 g, 141 mmol, 1.0 equivalents) was added in one portion using a solids funnel. Manual swirling was used to facilitate mixing initially. The mixture, heterogeneous at first, became homogeneous but remained turbid. (On smaller scales, the solution had become clear after 10-15 minutes.) Stirring was continued overnight (approximately 14 hours).

The solution was still turbid after overnight stirring and was run through a fine sinter funnel (10-15 μm pore size), which took more than 1 hour, producing a clear solution. The fine powdery residue was collected by scraping it from the sinter funnel (1.8 g). At the end of the filtration, the solution and the flask had cooled from evaporation under vacuum and substantial condensation of moisture was observed; the solution had turned cloudy again, possibly from some of the condensed water. The filtrate was transferred to a 2 L round-bottom flask and concentrated on a rotary evaporator at 40° C. bath temperature. Toluene (50 mL) was added to remove water by azeotropic distillation, which cleared the solution quickly. Regulated rough vacuum (down to 20 mbar) was followed by fine vacuum (approximately 0.1 mbar) to remove traces of solvents. The final product was obtained as a clear, viscous yellow oil (152.5 g, 98%).

### Infrared Spectroscopic Analysis of Gd(DPM)₃TOPO

Infrared spectra of Gd(DPM)₃TOPO were recorded on a Bruker Platinum FTIR-ATR (Bruker, Billerica, Mass.) and were used to confirm the identity as well as to estimate the purity of the compound. A drop of the compound obtained from the synthesis described above (900 mM, neat) was placed on the ATR diamond window, which had been blank-corrected with air. The spectra were measured between 4000-400 cm⁻¹ with a resolution of 1 cm⁻¹ (64 sample and background scans).

### Functional and Optical Analysis of Gd(DPM)₃TOPO

The ability of Gd(DPM)₃TOPO to levitate objects was tested using the following procedure. Gd(DPM)₃TOPO (7.85 g) was dissolved in tetrachloroethylene (6.14 mL, 9.95 g) to give a 0.45 M solution. The solution was transferred to a cuvette and three glass beads of known density (American Density Materials, Inc. Staunton, Va.) were levitated in the solution using the MagLev device as described in Angew. Chem. Int. Ed. 2020, 59:874-81. The cuvette with the levitating beads was imaged using a DSLR camera (Canon EOS Rebel T6i with a Canon EF 50 mm f/1.8 STM lens). The levitation heights of the density standards (using the ruler for reference) were determined in the software Microsoft PowerPoint. The levitation height is defined as the distance between the surface of the bottom magnet and the volumetric center of the levitating beads. The levitation heights and the known densities were plotted against each other to form a linear standard curve that can be used to measure the density of levitating objects in the MagLev device.

1. A process for synthesizing a paramagnetic compound comprising the steps of:
combining a first ligand precursor and a base in a first solvent to form a mixture;
allowing the first ligand precursor and the base to react to form a first ligand;
adding a metal compound to the mixture;
allowing time for the metal compound, the first ligand, and the base to react to form a ligand-metal intermediate;
isolating the ligand-metal intermediate from the mixture, subjecting it to liquid-liquid extraction, and concentrating it;
dissolving the ligand-metal intermediate in a second solvent to form a solution;
adding a second ligand to the solution;
allowing time for the second ligand and the ligand-metal intermediate to react to form the paramagnetic compound; and
isolating, and optionally purifying, the paramagnetic compound;
wherein:
the paramagnetic compound comprises a paramagnetic metal and at least one ligand that coordinates to the paramagnetic metal via electron donation; and
the paramagnetic compound is soluble in a non-aqueous solvent.

2. The process according to claim 1, wherein the first ligand precursor, base, and/or metal compound are in about stoichiometric equivalence.

3. The process according to claim 1, wherein the ligand-metal intermediate and second ligand are in about stoichiometric equivalence.

4. The process according to claim 1, wherein the first solvent is water, a C₁-C₄ alcohol, or a mixture thereof.

5. The process according to claim 4, wherein the first solvent is water, methanol, ethanol, propanol, isopropanol, butanol, isobutanol, tert-butanol, or mixtures thereof.

6. The process according to claim 5, wherein the first solvent is water, ethanol, or a mixture thereof.

7. The process according to claim 1, wherein the second solvent is a hydrocarbon solvent.

8. The process according to claim 7, wherein the second solvent is hexane or isomers thereof, heptane or isomers thereof, or mixtures thereof.

9. The process according to claim 8, wherein the second solvent is hexanes.

10. The process according to claim 1, wherein the first ligand precursor comprises a dialdehyde, a ketoaldehyde, diketone, a bipyridine, a phenanthroline, a diamine, a malonamide, a β-ketoester, or a β-ketoamide.

11. The process according to claim 10, wherein the first ligand precursor is a compound with the general structure of 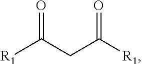
wherein each occurrence of R₁ is independently H, (C₁-C₂₀)alkyl, (C₂-C₂₀)alkenyl, (C₂-C₂₀)alkynyl, (C₃-C₁₀)cycloalkyl, (C₆-C₁₀)aryl, or (C₆-C₁₀)heteroaryl, each of which is optionally substituted with one or more substituents selected from the group consisting of halogen, R^{a}, OR^{a}, NR^{a}R^{b}, COR^{a}, CO₂R^{a}, or CONR^{a}R^{b}; and where R^{a} and R^{b} are independently selected from the group consisting of hydrogen and (C₁-C₆)alkyl.

12. The process according to claim 11, wherein each occurrence of R₁ is (C₁-C₆)alkyl.

13. The process according to claim 1, wherein the metal compound is a scandium, titanium, vanadium, chromium, manganese, iron, cobalt, nickel, cerium, praseodymium, neodymium, europium, gadolinium, terbium, dysprosium, copper, holmium, erbium, thulium, or lanthanum salt, hydrate, or oxide.

14. The process according to claim 13, wherein the metal compound is a gadolinium salt, hydrate, or oxide.

15. The process according to claim 14, wherein the metal compound is a gadolinium nitrate hydrate, a gadolinium oxide, or a gadolinium halide.

16. The process according to claim 15, wherein the metal compound is Gd(NO₃)₃.6H₂O, Gd₂O₃, or GdCl₃.

17. The process according to claim 1, wherein the base is a hydroxide base.

18. The process according to claim 17, wherein the base is an alkali or alkaline metal hydroxide.

19. The process according to claim 18, wherein the base is NaOH or KOH.

20. The process according to claim 1, wherein the second ligand is a compound with the general structure of 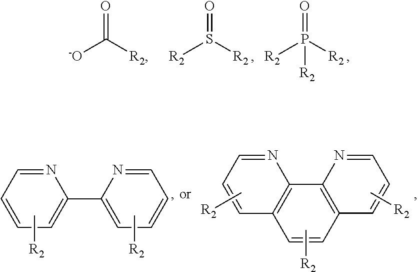
wherein each occurrence of R₂ is independently H, (C₁-C₂₀)alkyl, (C₂-C₂₀)alkenyl, (C₂-C₂₀)alkynyl, (C₃-C₁₀)cycloalkyl, (C₆-C₁₀)aryl, or (C₆-C₁₀)heteroaryl, each of which is optionally substituted with one or more substituents selected from the group consisting of halogen, R^{a}, OR^{a}, NR^{a}R^{b}, COR^{a}, CO₂R^{a}, or CONR^{a}R^{b}; and where R^{a} and R^{b} are independently selected from the group consisting of hydrogen and (C₁-C₆)alkyl.

21. The process according to claim 20, wherein the second ligand is a compound with the general structure of

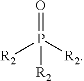

22. The process according to claim 20, wherein each occurrence of R₂ is independently (C₁-C₁₀)alkyl or (C₆-C₁₀)aryl.

23. The process according to claim 20, wherein each occurrence of R₂ is independently methyl, ethyl, propyl, butyl, pentyl, hexyl, heptyl, octyl, nonyl, decyl, phenyl, or isomers thereof.

24. The process according to claim 20, wherein each occurrence of R₂ is octyl.

25. The process according to claim 1, wherein the hydrophobic paramagnetic compound is 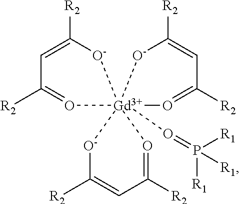
wherein each occurrence of R₁ and R₂ is independently (C₁-C₁₀)alkyl or (C₆-C₁₀)aryl.

26. The process according to claim 25, wherein the hydrophobic paramagnetic compound is

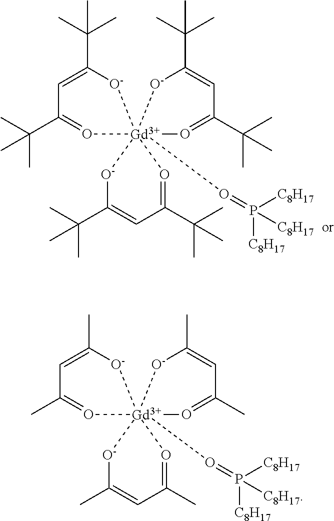

27. The process according to claim 1, wherein the liquid-liquid extraction comprises an aqueous phase and an organic phase.

28. The process according to claim 27, wherein the organic phase comprises a hydrocarbon solvent.

29. The process according to claim 28, wherein the organic phase comprises hexane or isomers thereof, heptane or isomers thereof, or mixtures thereof.

30. The process according to claim 29, wherein the organic phase comprises hexanes.

31. The process according to claim 1, wherein the overall yield of the paramagnetic compound is between about 95 and 100%, inclusive.

32. The process according to claim 31, wherein the overall yield of the paramagnetic compound is between about 98 and 100%, inclusive.

33. The process according to claim 1, wherein each step is performed under atmospheric conditions.

34. The process according to claim 1, wherein each time is between about 0.5 minutes and 2 days, inclusive.

35. The process according to claim 1, wherein the scale of the process is between about 1 mg to about 1 kg, inclusive.

36. The process according to claim 35, wherein the scale of the process is between about 1 mg to about 200 mg, inclusive.

37. The process according to claim 1, wherein the non-aqueous solvent is selected from the group consisting of acyclic and cyclic hydrocarbons, acyclic and cyclic halo- or per-halo hydrocarbons, aromatic hydrocarbons, acyclic and cyclic ethers, and acyclic and cyclic aldehydes, ketones, esters, amides, sulfides, sulfoxides, and sulfones, and a combination thereof.

38. The process according to claim 1, wherein:
the first ligand precursor is dipivaloylmethane;
the base is sodium hydroxide;
the metal compound is Gd(NO₃)₃.6H₂O;
the first solvent is a mixture of ethanol and water;
the ligand-metal intermediate is 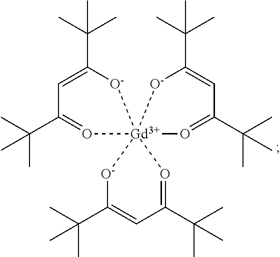
the second solvent is hexanes;
the second ligand is trioctylphosphine oxide;
and the paramagnetic compound is

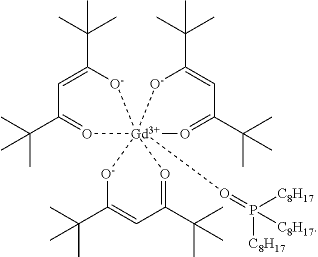

39. The process according to claim 38, wherein:
the liquid-liquid extraction comprises an aqueous phase and an organic phase comprising hexanes;
the overall yield of the paramagnetic compound is between about 98 and 100%, inclusive;
each step is performed under atmospheric conditions;
each time is between about 0.5 minutes and 2 days, inclusive; and
the scale of the process is between about 1 mg to about 1 kg, inclusive.

40. A hydrophobic paramagnetic compound made by a process comprising the steps of:
combining a first ligand precursor and a base in a first solvent to form a mixture;
allowing the first ligand precursor and the base to react to form a first ligand;
adding a metal compound to the mixture;
allowing time for the metal compound, the first ligand, and the base to react to form a ligand-metal intermediate;
isolating the ligand-metal intermediate from the mixture, subjecting it to liquid-liquid extraction, and concentrating it;
dissolving the ligand-metal intermediate in a second solvent to form a solution;
adding a second ligand to the solution;
allowing time for the second ligand and the ligand-metal intermediate to react to form the paramagnetic compound; and
isolating, and optionally purifying, the paramagnetic compound;
wherein:
the paramagnetic compound comprises a paramagnetic metal and at least one ligand that coordinates to the paramagnetic metal via electron donation; and
the paramagnetic compound is soluble in a non-aqueous solvent.

41. The paramagnetic compound according to claim 40, wherein the paramagnetic compound is

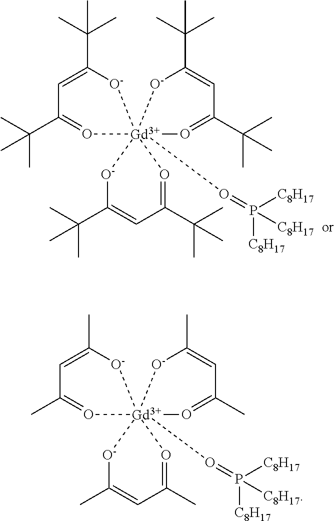

42. A magnetic levitation system comprising:
a first and second magnets having surfaces of their like-poles facing each other; and
a container disposed between the first and second magnets' like poles and containing a solution comprising a hydrophobic paramagnetic compound made by a process comprising the steps of:
combining a first ligand precursor and a base in a first solvent to form a mixture;
allowing the first ligand precursor and the base to react to form a first ligand;
adding a metal compound to the mixture;
allowing time for the metal compound, the first ligand, and the base to react to form a ligand-metal intermediate;
isolating the ligand-metal intermediate from the mixture, subjecting it to liquid-liquid extraction, and concentrating it;
dissolving the ligand-metal intermediate in a second solvent to form a solution;
adding a second ligand to the solution;
allowing time for the second ligand and the ligand-metal intermediate to react to form the paramagnetic compound; and
isolating, and optionally purifying, the paramagnetic compound;
wherein:
the paramagnetic compound comprises a paramagnetic metal and at least one ligand that coordinates to the paramagnetic metal via electron donation;
the first and second solvents are each non-aqueous solvents; and
the paramagnetic compound is soluble in a non-aqueous solvent.

43. A method of analyzing a sample comprising one or more solid compounds, the method comprising:
(a) providing the magnetic levitation system of claim 42;
(b) depositing the sample in the solution;
(c) allowing each of the solid compounds in the sample to migrate to a position in the container indicative of its density;
(d) analyzing one or more of the solid compounds to determine or confirm its identity;
(e) generating a profile of the position of the one or more compounds relative to the container;
(f) generating a database comprising a plurality of profiles, each of which corresponds to a known solid compound or a known mixture of solid compounds; and
(g) comparing the profile of the sample to the profiles in the database to determine its identity.

44. The method according to claim 43, wherein the sample comprises one or more controlled substances, adulterants, diluents, or a combination thereof.
